(19) United States
(12) Patent Application Publication
(10) Pub. No.: US 2017/0079864 A1
(43) Pub. Date: Mar. 23, 2017

(54) Surgical Support Devices and Systems

(71) Applicant: Emory University, Atlanta, GA (US)

(72) Inventors: Jonathan Riley, Atlanta, GA (US); Nicholas Boulis, Atlanta, GA (US); Sukreet Raju, Atlanta, GA (US); Annie McDonough, Atlanta, GA (US)

(21) Appl. No.: 15/273,349

(22) Filed: Sep. 22, 2016

Related U.S. Application Data
(60) Provisional application No. 62/221,662, filed on Sep. 22, 2015.

(51) Int. Cl. A61G 13/12

(52) U.S. Cl. CPC A61G 13/1295; A61G 13/122; A61G 13/123; A61G 13/1245; A61G 13/129; A61G 2210/50; A61G 2200/325

(57) ABSTRACT

These systems and devices can be placed on top of any commercially available standard operating table and therefore can provide a portable and inexpensive alternative to commercially available specialized operating tables. The system may include a frame body having a first end, a second end, and a length therebetween. The system may also include one or more movable platforms having a first end, a second end, and a length therebetween. Each moveable platform may be configured to move between the first end and the second end of the frame body. The system may also include one or more stabilizing support members disposed parallel to the first end and the second end of the frame body and configured to move along the length of the movable platform. Each stabilizing support member may include one or more securing members configured for removable, active and/or removable fixation with respect to the movable platform.

### CROSS-REFERENCE TO RELATED APPLICATIONS

This application claims the benefit of U.S. Provisional Application No. 62/221,662 filed Sep. 22, 2015. The entirety of this application is hereby incorporated by reference for all purposes.

### BACKGROUND

Specialized surgeries, like contemporary spinal surgery, can require proper positioning of the patient to provide the surgeon with adequate access to the surgical site. Specialized operating tables that can provide that access typically retail for a minimum of $100,000. These tables can also be bulky and can require use of a dedicated operating room. Thus, such specialized tables can be cost-prohibitive to resource-limited countries.

### SUMMARY

Thus, there is a need for a portable, cost-effective specialized operating platform.

This disclosure is directed to systems and devices that can be placed on top of any commercially available standard operating table. The systems and devices according to embodiments can therefore be a portable and inexpensive alternative to commercially available specialized operating tables.

In some embodiments, the disclosure may relate to a surgical support apparatus. In some embodiments, the apparatus may include a frame body having a first end, a second end, and a length therebetween. The apparatus may further include one or more platforms disposed on the frame body. The one or more platforms may include one more movable platforms having a first end, a second end, and a length therebetween. Each moveable platform may be configured to move along the length of the frame body. The apparatus may further include one or more stabilizing support members being configured to move along the length of the movable platform. Each stabilizing support member may include one or more securing members configured to removably, actively and/or passively fix a position of the each stabilizing support member along the length of the each movable platform.

In some embodiments, the apparatus may include a frame body having a first end, a second end, and a length therebetween. The apparatus may further include one or more platforms disposed on the frame body. The one or more platforms may include a first movable platform and a second movable platform, each of the first and second movable platforms having a first end, a second end, and a length therebetween. Each of the first and second moveable platforms may be configured to move along the length of the frame body and with respect to each other. The apparatus may also include one or more stabilizing support members being configured to move along the length of each of the first and second movable platforms. Each stabilizing support member may include a first flat surface and a second flat surface perpendicular to the first flat surface. The first flat surface may be longer than the second flat surface. The one or more stabilizing support members may include one or more securing members disposed on the first flat surface and/or the second flat surface. The one or more securing members may be configured to removably, actively and/or passively fix a position of the each stabilizing support member along the length of the each of the first and second movable platforms.

Additional advantages of the disclosure will be set forth in part in the description which follows, and in part will be obvious from the description, or may be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

The disclosure can be better understood with the reference to the following drawings and description. The components in the figures are not necessarily to scale, emphasis being placed upon illustrating the principles of the disclosure.

FIG. 1 shows a system according to some embodiments;

FIG. 2 shows another view of the system shown in FIG. 1;

FIGS. 3A-C show an exploded view of the system shown in FIG. 2;

FIGS. 4A and B show another view of the system shown in FIGS. 1 and 2, respectively;

FIGS. 5A and B show examples of configurations of the system shown in FIGS. 1-4 according to some embodiments;

FIG. 6 shows another view of the system shown in FIG. 1;

FIGS. 7A-C show views of an example of a movable platform and corresponding stabilizing support member for a system according to some embodiments;

FIGS. 8A and B show examples of stabilizing support members for a system according to some embodiments;

FIGS. 9A-D show views of an example of a movable platform and corresponding stabilizing support member for a system according to some embodiments;

FIG. 10 shows an example of a stabilizing support member for a system according to some embodiments; and

FIG. 11 shows an example of the system according to some embodiments, in use.

### DESCRIPTION OF THE EMBODIMENTS

In the following description, numerous specific details are set forth, such as examples of specific components, devices, methods, etc., in order to provide a thorough understanding of embodiments of the disclosure. It will be apparent, however, to one skilled in the art that these specific details need not be employed to practice embodiments of the disclosure. In other instances, well-known materials or methods have not been described in detail in order to avoid unnecessarily obscuring embodiments of the disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

Unless otherwise defined, all terms (including technical and scientific terms) used herein have the same meaning as commonly understood by one of ordinary skill in the art to which this invention belongs. It should be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “radiographic compatible” means that the so-called component(s) is suitable for use in standard intra-operative radiographic environment and as such is typically made of a non-ferromagnetic MRI compatible material(s) suitable to reside and/or operate in or proximate a conventional medical radiographic environment. Examples of radiographic-compatible (non-ferromagnetic) materials include, but are not limited to, various polymeric materials (e.g., plastics), wood materials, carbon fiber materials, glass-filled epoxies, and metals, among others, are a combination thereof.

The disclosure relates to devices and systems for providing a stabilized surgical support. The devices and systems according to the disclosure can be designed to be placed on top of any commercially available standard operating table. The devices and systems can maintain the crucial design elements of a commercially available operated table, like a fully devoted spinal table, while minimizing storage space and cost. By way of example, the devices and systems can: 1) accommodate protection of pressure points; 2) maintain appropriate (spinal) alignment and/or stabilization of the patient (e.g., spine) during the procedure; 3) be adjustable to a wide range of patient sizes; and/or 4) be used in conjunction with intra-operative radiography (e.g., intra-operative fluoroscopy).

Although the devices and the systems may be discussed with respect to spinal surgery, the devices and systems according to embodiments can be used in many surgical applications. Examples of the surgical applications may include but are not limited to 1) peri-rectal pathology (e.g., pilonidal sinus); 2) retro-peritoneal pathology approached posteriorly; 3) subcutaneous posterior pathology (e.g., thoracic, lumbar, pelvis, thigh, etc.); and/or 4) intra-thoracic pathology approached posteriorly.

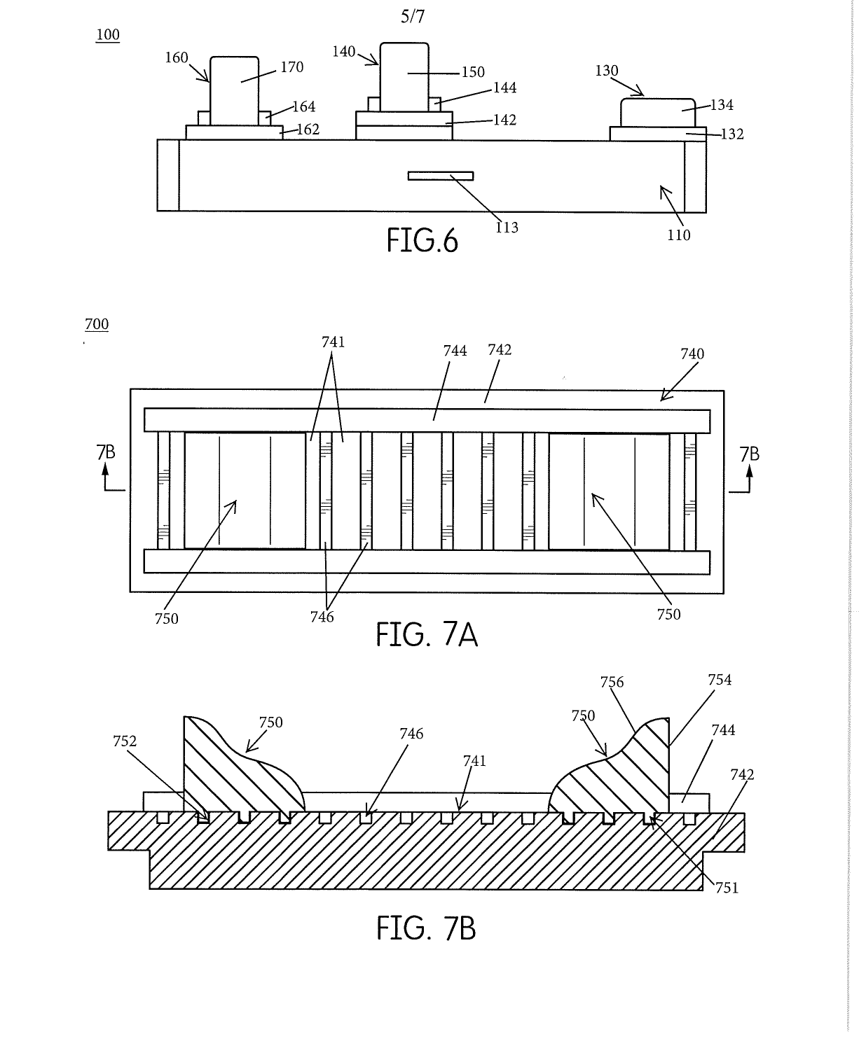

FIGS. 1-11 show surgical guide systems according to embodiments. In some embodiments, the system may include a frame body (also referred to as “frame”) configured to be disposed on top of an operating table, one or more platforms (also referred to as “cross-brace(s)”) configured to be disposed on the frame body relative to certain patient's anatomy, and one or more stabilizing support members (also referred to as “support(s)”) configured to be disposed on the one or more platforms and configured to support certain patient's anatomy. In some embodiments, the platforms and/or the stabilizing support member(s) may be removable from the frame body. In some embodiments, the frame body, the one or more platforms, the one or more stabilizing members, or any combination thereof may be made of a radiographic compatible material.

It should be understood that the surgical guide systems are not limited to the configuration and/or combination of the frame body, one or more platforms, and/or one or more stabilizing support members shown in and described with respect to the figures. The systems may include any combination of the embodiments the frame body, one or more platforms, and/or one or more stabilizing support members shown in and described with respect to the figures. It will also be understood that the systems may include additional and/or alternative frame bodies, platforms, stabilizing support members, among others, or any combination thereof; and/or omit one or more platforms, stabilizing support members, among others, or any combination thereof.

FIGS. 1-6 show a system 100 according to some embodiments. In some embodiments, the system 100 may include a frame body 110. As shown in these figures, the frame body 110 may include a first end 112, an opposing second end 114, and a length therebetween. The frame body 110 may also include a first side 116 and an opposing second side 118. The first side 116 and the second side 118 may extend between the first end 112 and the second end 114. The length of the first side 116 and the second side 118 may correspond to the length of the frame body 110 and the length of the first end 112 and the second end 114 may correspond to the width of the frame body 110. In some embodiments, the frame body 110 may include an opening 111 disposed in the center of the frame body between the sides 116 and 118 and the ends 112 and 114. In some embodiments, the opening 111 may be configured to hold and store the movable components of the system 100 (e.g., the platforms 140 and 160, supports 136, 140 and 170, etc.), for example, when the system 100 is not in use. The opening 111 may be partially open, for example, by including a base member on one side, which can be configured to face the operating table, of the frame body 110.

In some embodiments, the frame body 110 may be configured to be folded or collapsed. For example, the frame body 110 may include a hinge disposed on each side 116 and 118 so that the frame body folds. In this example, when folded, the first end 112 may be adjacent to the second end 114 of the frame body 110. This may can enhance the portability and storage capability of the system 100 when not in use.

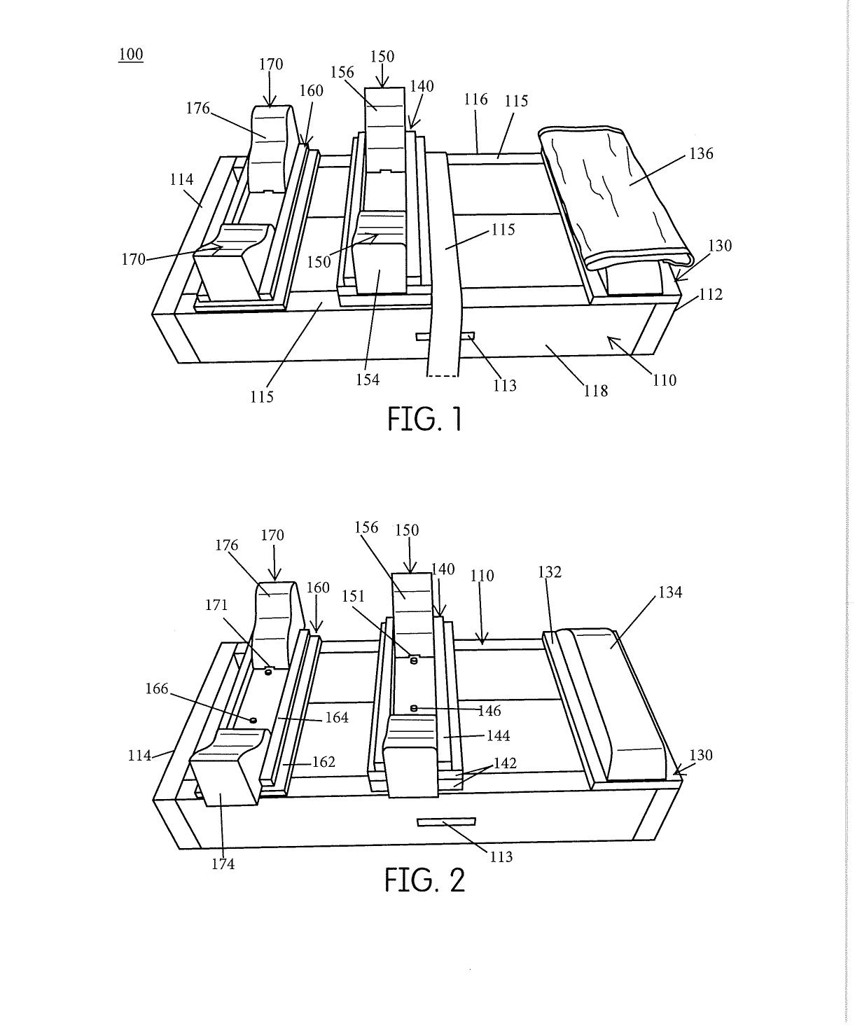

In some embodiments, the system 100 may include one or more fastening members configured to secure the frame body 110 to an operating table. In some embodiments, for example, as shown in FIG. 1, the one or more fastening members may include but are not limited to an opening 113 in the frame 110 configured to receive a complimentary member disposed on the bed and/or frame, a strap 115 that is configured to be disposed on the top surface of the frame and/or within the opening 113 and attach to the operating table, among others, or any combination thereof. FIGS. 2 and 3A-6 show views of the system 100 without the strap.

In some embodiments, the frame body 110 may include one or more guiding member(s) 115 disposed on a surface one or more sides on which one or more of the platform(s) may be (i) adjustably moved and/or (ii) passively and/or actively fixed/secured to with respect to the frame body 110. By way of example, the frame body 110 may include a guiding member 115 disposed along the length of the first side 116 and/or a guiding member 115 disposed along the length of the second side 118. For example, the guiding member 115 may disposed on the top surface of the sides 116 and 118 as shown in FIG. 1. In some embodiments, the guiding member 115 may be disposed on the surface of each of the sides 116 and 118 that face the center 111 of the frame body 110. In some embodiments, the frame body 110 may additionally or alternatively include guiding member(s) 115 disposed along the first end 112 and/or the second end 114. In some embodiments, the guiding member(s) 115 may include but are not limited to a rail, grooves, among others, or any combination thereof. The guiding member(s) 115 may disposed along a partial length and/or the entire length of the sides 116 and 118 and/or ends 112 and 114 of the frame body 110. The guiding member(s) 115 may be disposed continuously and/or discontinuously (e.g., the rail and/or groove may include intervening spaces) along that length.

In some embodiments, the one or more platforms may include one or more movable platforms and/or one or more fixed or stationary platforms with respect to the length of the frame body 110. In some embodiments, the one or more platforms may each include a platform base. The platform base may be fixed and/configured to be movable with respect to the frame body 110. In some embodiments, the one or more movable platforms may be configured to move along the guiding member 115 of the frame body 110.

In some embodiments, the one or more platforms may be configured to receive the one or more stabilizing support members, for example, with respect to its platform base. In some embodiments, the one or more stabilizing support members may be configured to be removably, fixed or stationary with respect to a platform base, movable with respect to a platform base, and/or a combination thereof. For example, one or more platforms may include one or more guiding members configured to receive and guide the one or more stabilizing support members with respect to that platform.

In some embodiments, the system may include one or more securing members configured to actively and/or passively (e.g., in combination with patient's weight) removably fix the position of the one or more stabilizing support members with respect to the platform and/or each other. For example, one or more securing members may be configured to actively, removably fix by mechanically connecting the stabilizing support member(s) to the platform and/or another stabilizing support member(s). By way of another example, one or more securing members may be configured to passively, removably fix by mechanically associating the stabilizing support member(s) to the platform and/or another stabilizing support member(s) and relying on the patient's weight to removably fix the position of one or more stabilizing support members to the platform and/or the other stabilizing support member(s).

In some embodiments, the one or more securing members may be disposed on the platform (e.g., the platform base), may be disposed on one or more of the stabilizing support members, may be separate from the platform and/or the stabilizing support member(s), among others, or any combination thereof (e.g., the one or more stabilizing members may be complimentary). The one or more securing members may include but are not limited to one more of notches, holes, brackets, channels, protruding and/or recessed pattern grooves, other recessed or protruding members (e.g., posts, pegs, etc.), any fastening member (e.g., screw, ties, etc.), among others, or any combination thereof. In some embodiments, if there are more than one securing members disposed on the platform (e.g., platform base) and/or the one or more stabilizing support members, the more than one securing members may be disposed in a pattern (e.g., set spacing).

In some embodiments, the one or more stabilizing support members may include but are not limited to pad, molded support, cushion, among others, or a combination thereof. By way of example, the one or more stabilizing support members may include a molded support on which a softer support (e.g., pad) can be disposed. In this example, the softer support may be configured to provide soft cushioning along areas of patient contact with the platform(s) and/or another support. In some embodiments, for two or more stabilizing support members that are disposed on each other, one or more of those stabilizing support members may include one or more securing members (e.g., notch, hole, groove, etc.) configured to actively and/or passively removably fix or secure the stabilizing support members with respect to each other. In a further example, the molded support and/or the softer support may include securing member(s) so that the softer support can be removably fixed to the molded support.

In some embodiments, the one or more stabilizing support members may have dimensions, shape, geometry, material(s), among others, or a combination thereof, specific to the patient anatomy to be supported. For example, in some embodiments, the one or more stabilizing support members may have surface complimentary to the patient anatomy to be supported.

In some embodiments, the one or more stabilizing support members may include material, such as but not limited to foam (e.g., viscoelastic), gel, polyurethane, plastic, liquid, air, fluidized air, among others, or any combination thereof. In some embodiments, the one or more stabilizing support members may be configured to be inflatable, for example, with air and/or liquid. The one or more stabilizing support members may have a thickness and/or viscosity sufficient to cushion the patient anatomy to be supported.

In some embodiments, the one or more stabilizing support members may be sterilizable, reusable, and/or disposable. It should be understood that the number, configuration, dimensions, material, among others, or a combination thereof of the one or more stabilizing support members are not limited to those shown and described with the respect to the figures. For example, the system may include a different configuration/combination/number of one or more stabilizing support members, include different stabilizing support member(s), omit stabilizing support member(s), among others, or any combination thereof.

In some embodiments, the one or more platforms may include a platform 130, for example, configured to support the thoracic region of a patient (hereinafter referred to as thoracic platform 130). In some embodiments, the thoracic platform 130 may include a platform base 132. In some embodiments, the thoracic platform 130 may be a fixed/stationary platform (with respect to the frame body). For example, the platform base 132 may fixed with the respect to the first end 112 and the nearby sides 116 and 118 of the frame body 110. This can increase structural integrity by providing a fixed cross-brace. In use, for example, for spinal surgery, the mediastinum of a patient can be positioned over the thoracic platform 130. In other embodiments, the thoracic platform 130 may be movable with respect to the frame body 110.

In some embodiments, the system 100 may include one or more stabilizing support members disposed on the thoracic platform 130, for example, on the platform base 132, as shown in FIG. 1. As shown, the system 100 may include two stabilizing support members disposed on the thoracic platform. In this example, the one or more stabilizing support members may include two stabilizing support members 134 and 136. The stabilizing support member134 may be a molded support disposed on the base 132 and the stabilizing support member 136 may be a cushioning pad, for example, a gel cushion pad, disposed on the support member 134. In some embodiments, the support member 134 and/or the support member 136 may have any shape. In some embodiments, the support member 134 and/or the support member 136 may include a substantially, flat top surface as shown in FIG. 1. In some embodiments, the support member 134 and/or the support member 136 may be concave. By way of example, the support member 134 and/or the support member 136 may have a gradual tapered concave depression on one side. This can better correspond to thoracic region of a patient thereby relieving some pressure on the patient, for example, from the system 100.

In some embodiments, the stabilizing support member 136 may be removable with respect to the platform base 132 and/or the support member 134 so as to be disposable. For example, FIGS. 2-6 show the system 100 without the support member 136.

In some embodiments, the one or more movable platforms may include a platform 140 configured to support the pelvic region of a patient (hereinafter referred to as pelvic platform 140), a platform 160 configured to support the thigh region of a patient (hereinafter referred to as thigh platform 160), among others, or any combination thereof. The pelvic platform 140 and the thigh platform 160 may be configured to independently move with respect to each other and the length of the frame body 110. In some embodiments, the pelvic platform 140 and thigh platform 160 may be movable with respect to each other and/or the length of the frame body 110 by moving the platforms 140 and 160 along the guiding members 115 disposed on the sides 116 and 118 of the frame body 110. In this way, the position of the platforms 140 and 160 can be adjusted with respect to each other, the length of the frame body 110, and/or the thoracic platform 130, for example, based on the anatomy of a patient, the surgery to be performed on that patient, among others, or any combination thereof.

In some embodiments, the pelvic platform 140 may include a platform base 142, a guiding member 144 disposed on one or more sides of the platform base 142, and a plurality of spaced securing members 146 disposed on the top surface 141 of the platform base 142, as shown in FIGS. 1, 2, 3B, and 4-6. As shown in these figures, the thigh platform 160 may also include a platform base 162, a guiding member 164 disposed on one or more sides of the platform base 162, and a plurality of spaced securing member 166 disposed on the top surface 161 of the platform base 162. The guiding members 144 and 164 may be configured to guide the movement and/or positioning of one or more stabilizing support members with respect the length of the respective platforms 140 and 160 and/or and/or the respective one or more securing members 146 and 166. In some embodiments, the guiding members 144 and 164 may include a guiding rail in which one or more stability support members may move and/or fixed.

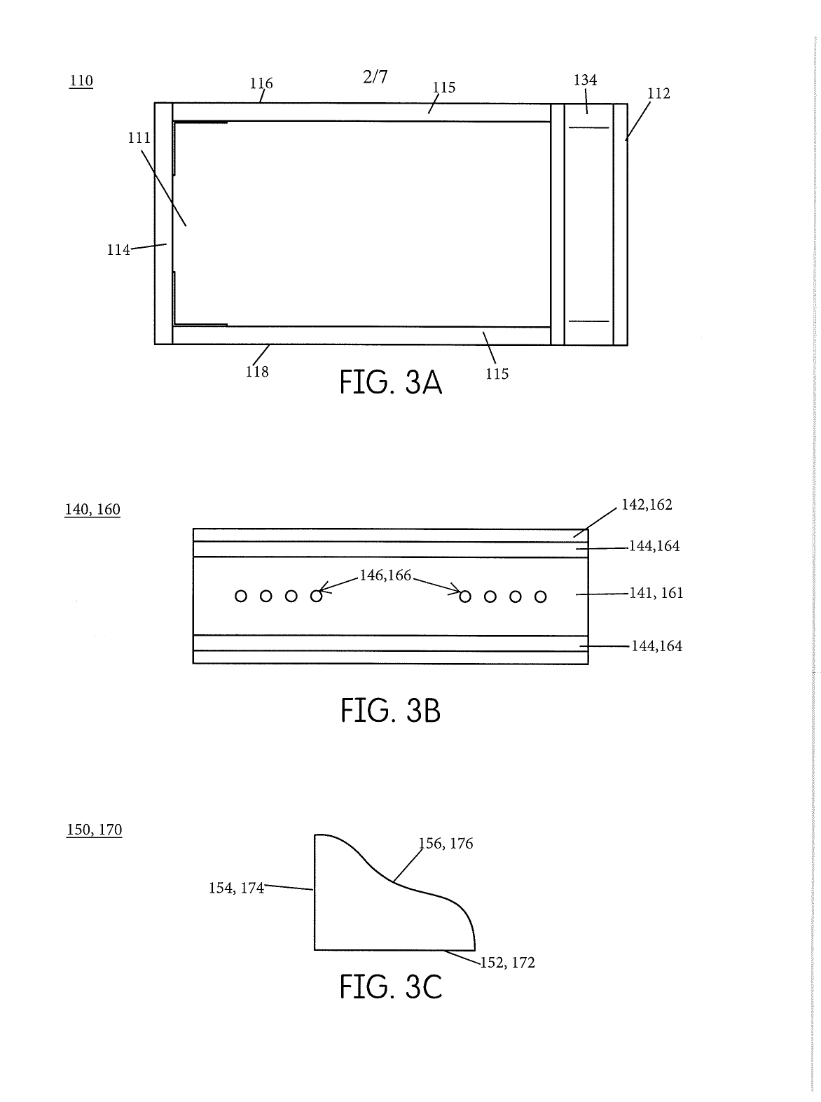

The one or more securing members 146 and 166 may include any number, shape, spaced distance, size, etc. For example, in FIG. 3B, the securing members 146 and 166 may include eight securing members. In this example, a first set of four securing members 146 and 166 are evenly spaced on one side and second set of four securing members 146 and 166 are evenly spaced on the other side of the respective platform. In some embodiments, the securing members 146 and 166 may be raised posts as shown in these figures. The securing members 146 and 166 may be configured to interact with a complimentary component of one or more stabilizing support members to removably, passively secure the position of that stabilizing support member with respect to the platform 140 and 160, respectively.

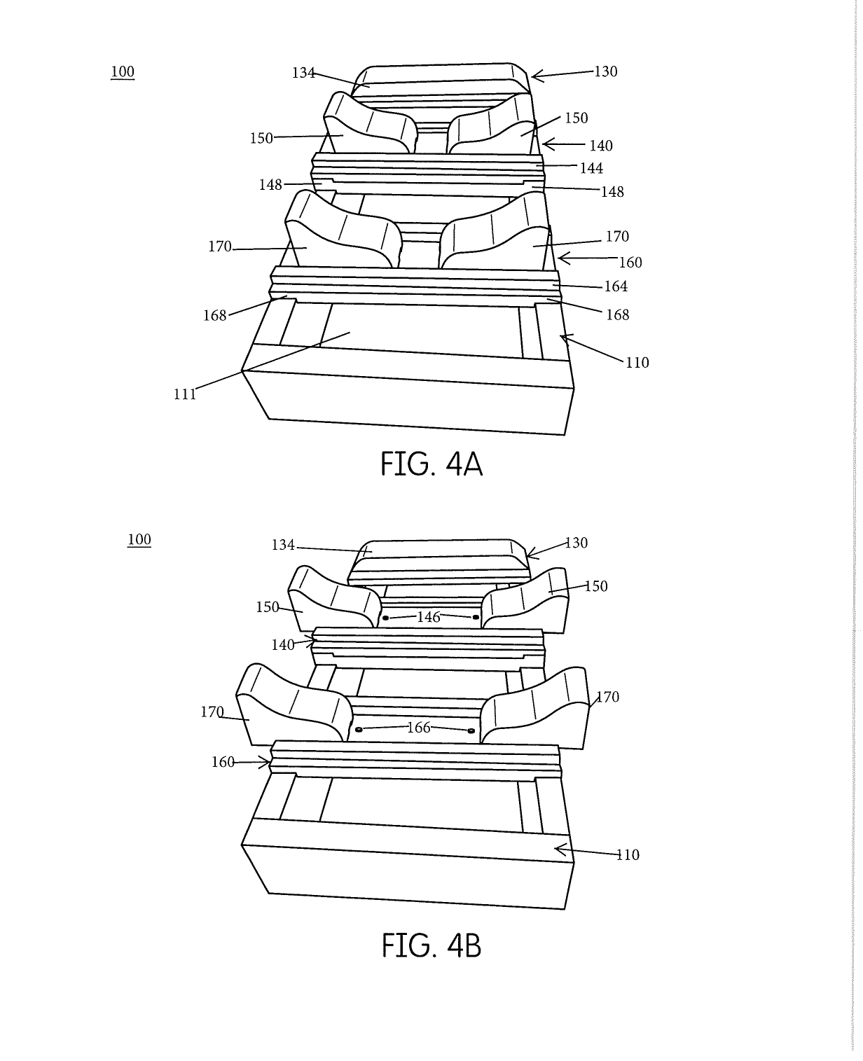

In some embodiments, the pelvic platform 140 and the thigh platform 160 may be configured to be (removably) actively and/or passively secured or fixed with respect to the frame body 110, for example, by fixing the position of the platforms 140 and 160 with respect to the guiding members 115. In some embodiments, as shown in FIGS. 4A and 4D, the platforms 140 and 160 may each include a cut-out 148 and 168 respectively disposed at each end of the respective platform base 142 and 162. The cut-outs 148 and 168 may have a shape complimentary to the guide member 115 disposed on the sides 116 and 118 and/or the sides 116 and 118 of the frame body 110. In some embodiments, the cut-outs 148 and 168 may include one or more securing members (e.g., grooves, notches, etc.) that are disposed on the surface facing the guide member 115 and that are complimentary to that guide member 115.

In some embodiments, the thoracic platform 130, pelvic platform 140, and/or thigh platform 160 may be substantially identical or different. For example, the thoracic platform 130, pelvic platform 140, and/or thigh platform 160 may have the same and/or different shape, dimensions, material, number and/or type of guiding member(s) and/or securing member(s), among others, or combination thereof. For example, as shown in FIGS. 1, 2, 4A-B and 6, the platform base 142 of the pelvic platform 140 may be higher (additional height (e.g., two inches of height) than the platform base 132 of the thoracic platform 130 and the platform base 162 of the thigh platform 160. This can optimize the alignment between the thoracic and pelvic supports.

In some embodiments, the system 100 may include one or more stabilizing support members configured to move with respect to the platforms 140 and 160. In some embodiments, the system 100 may include any number of stabilizing support members configured to be disposed with respect to the pelvic platform 140 and/or the thigh platform 160. As shown in the FIGS. 1, 2, and 4A-6, the system 100 may include two stabilizing support members 150 disposed on the platform 140 and two stabilizing support members 170 disposed on the platform 160. It should be understood that the number of stabilizing support members to be disposed on the respective platform may depend on the desired position of the patient, the procedure to be performed, among others, or combination thereof. For example, only one stabilizing support member disposed on one or both of the platforms may be needed to position a patient for a medical procedure. In this example, the stabilizing support members 150 and 170 can be substantially identical. However, the stabilizing support members 150 and 170 may be different with respect to each other, the platform, or a combination thereof. For example the one or more stabilizing support members 150 and/or 170 may differ in shape, dimensions, material(s), among others, or a combination thereof.

In some embodiments, the one or more stabilizing support members 150 and 170 may include an angled or curved surface and at least one flat surface. In some embodiments, the one or more stabilizing support members 150 and 170 may include one or more flat surfaces. In some embodiments, the flat surfaces may have the same and/or different length. For example, as shown in FIGS. 1, 2, and 3C-6, each of the stabilizing support members 150 and 170 may include a first flat surface 152 and 172 and a second flat surface 154 and 174, respectively. The first flat surfaces 152 and 172 may be longer than the second flat surfaces 154 and 174. In some embodiments, each of the stabilizing support members 150 and 170 may include a curved or angled surface 156 and 176 that extends between the first flat surface 152 and 172 and the second flat surface 154 and 174, respectively. In use, for example, the angled or curved surfaces 156 and 176 may be configured to increase stability of the patient with respect the frame 110.

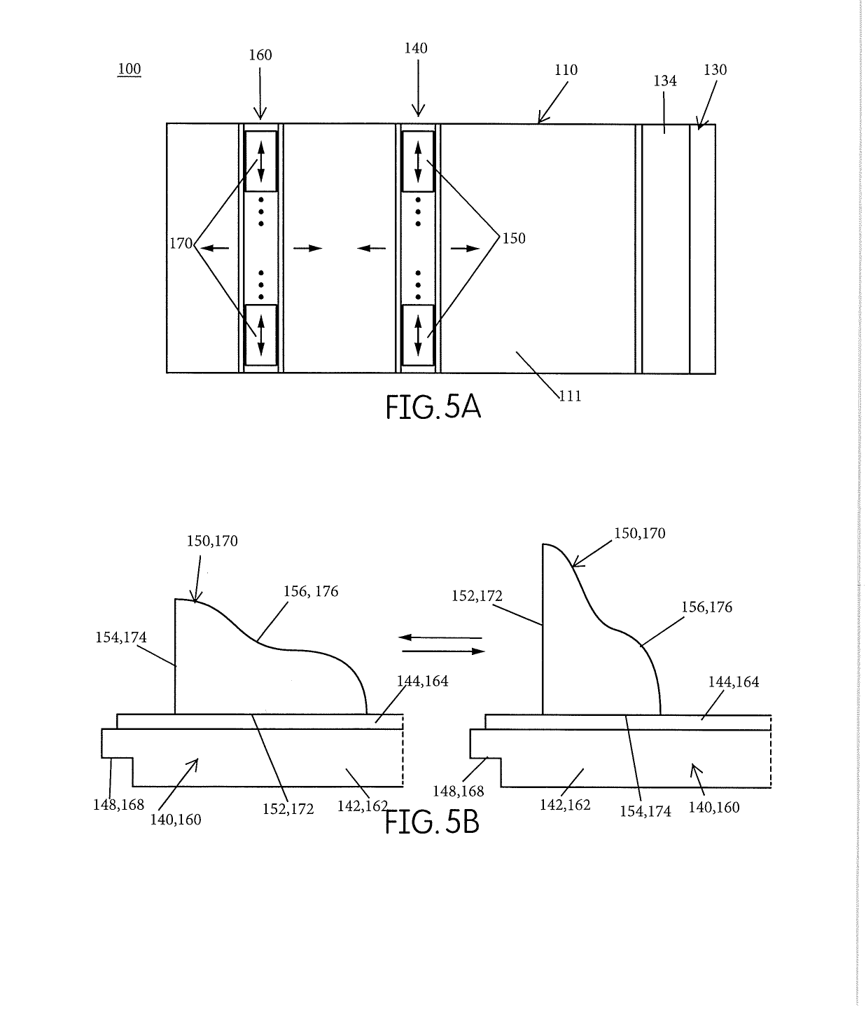

In some embodiments, each of the stabilizing support members 150 and 170 may be configured to move with respect to and removably fixed or secured (passively and/or actively) to the respective platform in two different configurations, for example, by rotating the stabilizing support member 90°, as shown FIG. 5B. For example, each of the flat surfaces 152/172 and 154/174 may be configured to interact with the guiding member(s) 144/164 and the securing member(s) 146/166 of the respective platform. As shown in FIG. 4D, for example, the second flat surfaces 154 and 174 of each support members 140 and 160 can be positioned vertically and/or horizontally with respect to the respective platform. In this way, the geometry/orientation of the stabilizing support members 150 and 170 can be easily adjusted, thereby improving patient stability based on the orientation and/or anatomy of the patient.

In some embodiments, each of the stabilizing support members 150 and 170 may include a securing member 151 and 171 on each flat surface (152, 154, 172, and 174) of the respective support member. In this example, the securing members 151 and 171 may be complimentary to the securing members 146 and 166 disposed on the platforms 140 and 160, respectively. In this example, each of the securing members 151 and 171 may be a cut-out and/or channel that is configured to center over the members 146 and 166 (e.g., posts) when the respective stabilizing support member is moved on the respective platform (e.g., using the respective guiding members) and passively fix the position of the respective stabilizing support member to the respective platform. In use, when the patient is placed on the frame, the patient's weight can maintain and reinforce the locking or fixing effect of the securing members of the stabilizing support member(s) with respect to the platform.

The system 100 may be configured to accommodate a range of different patient widths, patient heights, procedures to be performed, among others, or combination thereof, for example, as shown in FIGS. 5A and B. For example, as shown in FIG. 5A, the stabilizing support members 150 and 170 can be positioned with respect to the platforms 140 and 160 to correspond to a width of a patient by moving the stabilizing support members 150 and 170 along the guiding members 144 and 164, respectively, with respect to the securing members 146 and 166. In some embodiments, for example, FIGS. 1 and 4A, show the system 100 having the stabilizing support members 150 and 170 in a fully medialized configuration, for example, for a narrower width person, and FIGS. 2 and 4B show the system 100 having the stabilizing support members 150 and 170 in a fully lateralized configuration, for a wider width person. The platforms 140 and 160 can also be positioned with respect to the frame body 110 to correspond to a height of a patient by independently moving the platforms 140 and 160 along the length of the frame body 110 via the guiding members 115. In some embodiments, the configuration of the stabilizing support members 150 and/or 170 may be adjusted with respect to the respective platform to correspond to the patient anatomy and/or procedure to be performed by changing the flat surface (152 or 154, 172 or 174) of the respective support member that interacts with the respective platform base, for example, as shown and described above with respect to FIG. 5B.

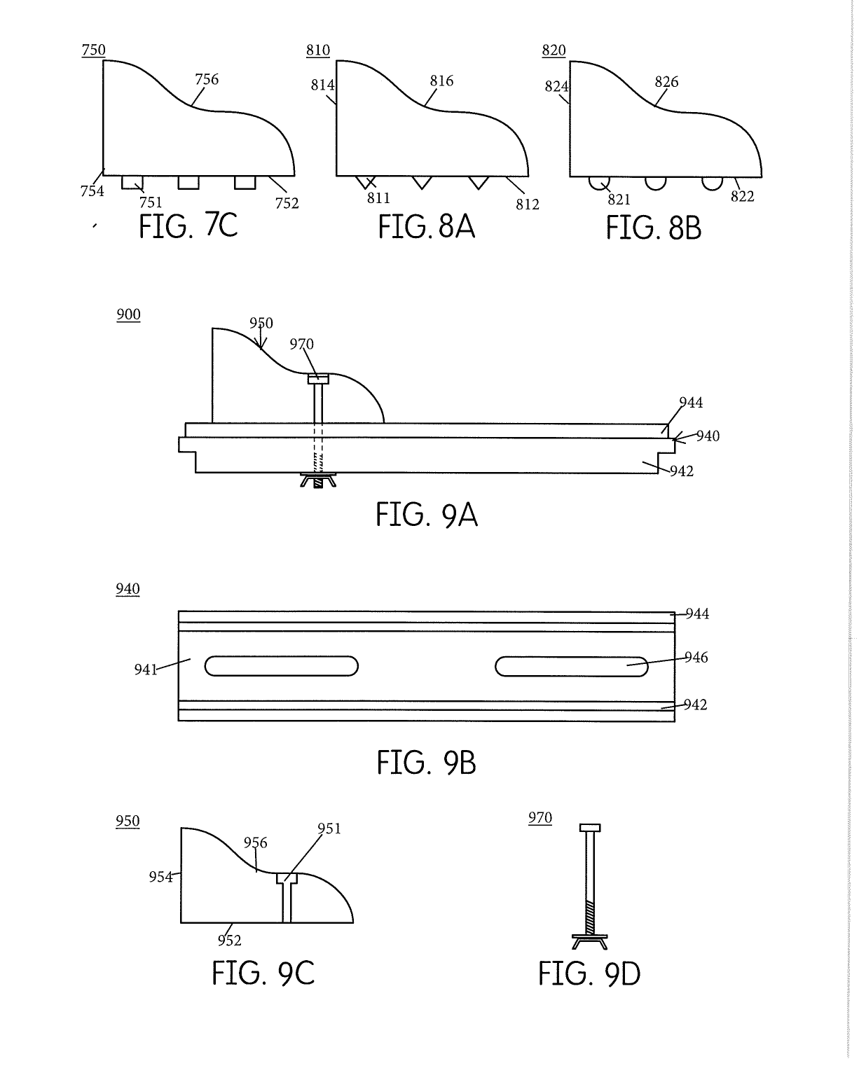

In some embodiments, the system may one or more alternative and/or additional platforms and/or stabilizing support members. For example, the system may include one or more platforms having different one or more securing members configured to passively and/or actively (removably) fix the one or more stabilizing support members with respect to those platforms and one or more stabilizing support members having the corresponding securing members. FIGS. 7-10 show examples of different securing members disposed on a movable platform and/or different stabilizing support members according to some embodiments. For example, the system 100 may include one or more of the platform(s) and/or stabilizing support member(s) shown in any of FIGS. 7-10 in addition to or instead of the platforms 130, 140, and 160 shown in FIGS. 1-6 and 11.

FIGS. 7A-C show an example 700 of a movable platform 740 and corresponding stabilizing support members 750. Like the movable platforms 140 and 160, the platform 740 may include a platform base 742, a guiding member 744 (e.g., guide rail) disposed on each side along the length of the base 742, and a plurality of securing members 746 disposed on the top surface 741 of the platform base 742 between the members 744. In this example, the securing members 746 may include a plurality of evenly spaced recessed grooves or notches disposed with respect to the top surface 741 and extend across the width of the base 742 in a pattern.

Like the stabilizing support members 150 and 170, the stabilizing support members 750 may include a first flat surface 752, a second flat surface 754 that is perpendicular to the first flat surface 752, and a curved or angled surface 756 that extends between the first flat surface 752 and the second flat surface 754. The stabilizing support members 750 may include one or more securing members 751 disposed on one or more of the flat surfaces 752 and 754. While the securing members 751 are shown to be disposed on the first flat surface 752 in FIGS. 7A-C, it should be understood that the other flat surface 754 may also include the securing members 751. In some embodiments, the securing members 751 may have a pattern and shape to correspond to the pattern and shape of the securing members 746 disposed on the platform 740. In this example, the securing members 751 may be protruding members that have the rectangular shape that corresponds to the rectangular shape of the securing members (e.g., grooves or notches) 746 and be disposed in a pattern that corresponds to at least a portion of the pattern of the securing members 746. Thereby, the securing members 751 and 746 allow the position of the stabilizing support members 750 to be removably, passively fixed with respect to a platform (e.g., preventing lateral movement of the stabilizing support member), for example, while the patient is disposed on the frame.

Although the grooves are shown to be continuous along the length of the platform and to be recessed, the securing members 746 and the corresponding securing members 751 may be in a different pattern with respect to the platform base 742. For example, the securing members 746 may be disposed in two sets like the two sets of the securing members 146 shown in FIGS. 1-6. In some embodiments, the securing members 746 and the corresponding securing members 751 may have a different shape.

FIGS. 8A and 8B show examples of stabilizing support members having different shaped securing members according to some embodiments. The securing members are not limited to the shapes shown and may have any shape that includes but are not limited to a rectangular, triangular, circular, among others, or a combination thereof. It should be understood that the corresponding platform may include securing members that are complimentary to that shape and pattern and a system may include one or more of the stabilizing support members shown in these figures, thereby allowing the stabilizing support member to removably, passively fix the position of that stabilizing support member with respect to a platform (e.g., preventing lateral movement of the stabilizing support member), for example, while the patient is disposed on the frame.

FIG. 8A shows a stabilizing support member 810 including a plurality of spaced securing members 811 that may have a triangular shape. Like the stabilizing support members 750, the stabilizing support member 810 may include a first flat surface 812, a second flat surface 814 that is perpendicular to the first flat surface 812, and a curved or angled surface 816 that extends between the first flat surface 812 and the second flat surface 814. The stabilizing support member 810 may include the one or more securing members 811 disposed on one or more of the flat surfaces 812 and 814. While the securing members 811 are shown to be disposed on the first flat surface 812, it should be understood that the other flat surface 814 may also include the securing members 811. Like the securing members 751, the securing members 811 may protrude from one or more surfaces of the stabilizing support member 810 and be configured to interface with one or more securing members disposed on a platform having a corresponding shape and in a pattern that corresponds to at least a portion of the pattern of the securing members 811.

FIG. 8B shows a stabilizing support member 820 including a plurality of spaced securing members 821 that may have a circular shape. Like the stabilizing support members 750 and 810, the stabilizing support member 820 may include a first flat surface 822, a second flat surface 824 that is perpendicular to the first flat surface 822, and a curved or angled surface 826 that extends between the first flat surface 822 and the second flat surface 824. The stabilizing support member 820 may include the one or more securing members 821 disposed on one or more of the flat surfaces 822 and 824. While the securing members 821 are shown to be disposed on the first flat surface 822, it should be understood that the other flat surface 824 may also include the securing members 821. Like the securing members 751 and 811, the securing members 821 may protrude from one or more surfaces of the stabilizing support member 820 and be configured to interface with one or more securing members disposed on a platform having a corresponding shape and in a pattern that corresponds to at least a portion of the pattern of the securing members 821.

In some embodiments, the system may include one or more securing members configured to actively fix a position of one or more stabilizing support members with respect to a platform. FIGS. 9A-D and 10 show examples of securing members disposed on the platform and/or the stabilizing support member configured for active fixation according to some embodiments.

FIGS. 9A-D show an example 900 of a movable platform 940 and a stabilizing support member 950. Like the movable platforms 140 and 150, the platform 940 may include a platform base 942, a guiding member 944 (e.g., guiding rail) disposed on each side along the length of the base 942, and a plurality of securing members 946 disposed on the top surface 941 of the platform base 942 between the guiding members 944. In this example, the securing members 946 may include a set of elongated cut-outs disposed in the platform base 942 along the length of the platform 940. The securing members 946 are not limited to shape and number of cut-outs shown in the figures. In some embodiments, the securing members 946 may include one or more cut-outs having a different shape, pattern, and/or number. The securing members 946 can allow for continuous adjustability with respect to positioning of the stabilizing support members 950 along the platform 940. In this way, for example, the stabilizing support members 950 can be easily adjusted with the patient in position (disposed on the platform).

As shown in FIGS. 9A, C and D, like the stabilizing support member 610, the stabilizing support member 950 may include a first flat surface 952, a second flat surface 954 that is perpendicular to the first flat surface 952, and a curved or angled surface 956 that extends between the first flat surface 952 and the second flat surface 954. The stabilizing support member 950 may include the one or more securing members 951 disposed with respect to one or more of the flat surfaces 952 and 954. In this example, the one or more securing members 951 may include a channel configured to receive a complimentary fastener. While the securing member (channel) 951 is shown to extend between the first flat surface 952 and the curved surface 956, it should be understood that another securing member 951 (e.g., another channel) may be disposed so as to extend between the other flat surface 954 and the curved surface 956.

In this example, the position of the stabilizing support member 950 can be actively fixed to the platform by a fastener 970. The fastener 970 may include but is not limited to a lag bolt and wingnut. In some embodiments, the one or more securing members (e.g., channel) 951 may be countersunk so that the fastener does not protrude from the support. Also, while one stabilizing support member 1950 and fastener 970 are shown, it should be understood that the system may include more than one stabilizing support member 950 and fasteners 970.

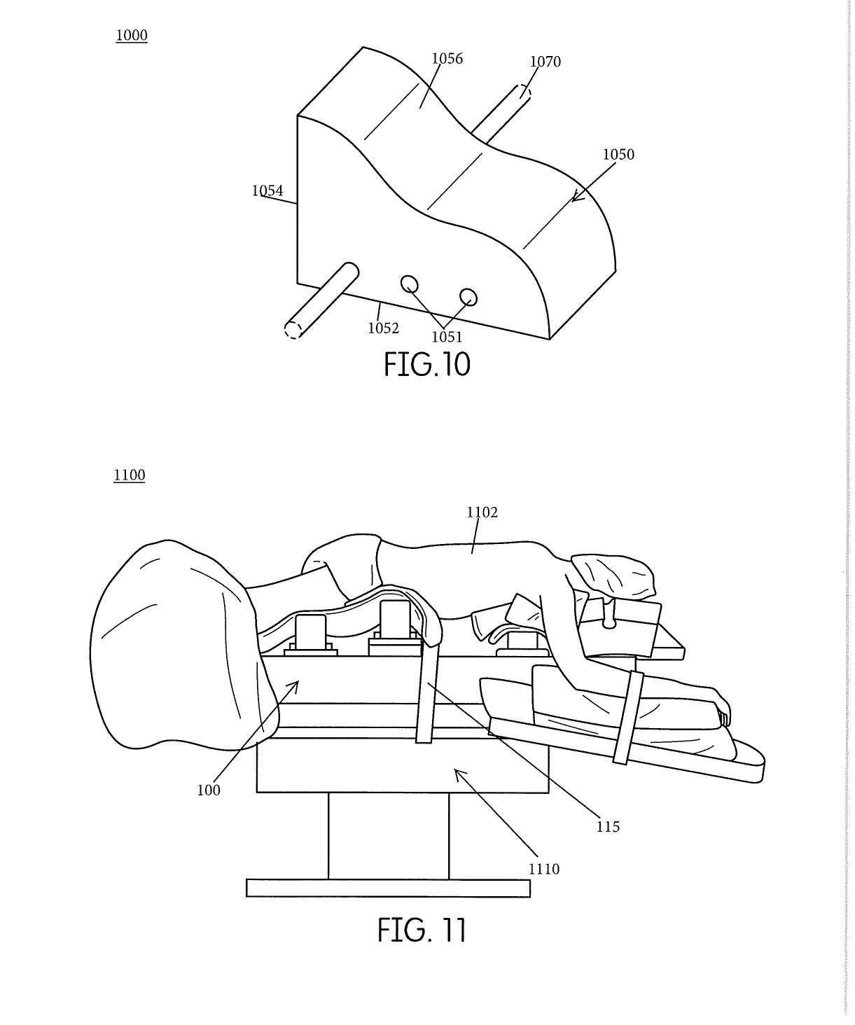

FIG. 10 shows another example 1000 of a stabilizing support member 1050 that includes one or more securing members 1051 configured for active fixation. Like the stabilizing support member 950, the stabilizing support member 1050 may include a first flat surface 1052, a second flat surface 1054 that is perpendicular to the first flat surface 1052, and a curved or angled surface 1056 that extends between the first flat surface 1052 and the second flat surface 1054. In some embodiments, the stabilizing support member 1050 may include one or more securing members 1051 that transverse through the stabilizing support member 1010 and along the length of the one or more of the flat surfaces 1052 and 1054. In some embodiments, the securing members 1051 may include a circular opening or channel that transverses through the sides (perpendicular to the surfaces) of the stabilizing support member 1050.

In some embodiments, the securing members 1051 may have a different shaped channel (e.g., square, tapered, etc.), number (more or less than 3 members), spacing, among others, or any combination thereof. While the three securing members 1051 are shown to be disposed to be parallel first flat surface 1052, it should be understood that the other flat surface 1054 may also include one or more of securing members 1051. In this example, the position of the stabilizing support member 1050 can be actively fixed to complimentary securing member disposed on a platform by one or more fasteners 1070. The fastener 1070 may include but is not limited to a protruding member, such as a peg having a shape that corresponds to the securing member 1051 of the stabilizing support member 1050. In this example, one or more securing members of the platform may be disposed along the guiding member and may be a circular hole that corresponds to the size of the fastener 1070. Also, while one stabilizing support member 1050 and fastener 1070 are shown, it should be understood that the system may include more than one stabilizing support member 1050 and fasteners 1070.

FIG. 11 shows an example of the portable spinal system 1100 according to embodiments secured to an operating table 1110 by strap 115 and on which a patient 1102 is positioned for a procedure.

While the disclosure has been described in detail with reference to exemplary embodiments, those skilled in the art will appreciate that various modifications and substitutions may be made thereto without departing from the spirit and scope of the disclosure as set forth in the appended claims. For example, elements and/or features of different exemplary embodiments may be combined with each other and/or substituted for each other within the scope of this disclosure and appended claims.

What is claimed:

1. A surgical support apparatus, comprising:
a frame body having a first end, a second end, and a length therebetween;
one or more platforms disposed on the frame body, the one or more platforms including one more movable platforms having a first end, a second end, and a length therebetween, each moveable platform being configured to move along the length of the frame body; and
one or more stabilizing support members being configured to move along the length of the movable platform, each stabilizing support member including one or more securing members configured to removably, actively and/or passively fix a position of the each stabilizing support member along the length of the each movable platform.

2. The surgical support apparatus according to claim 1, wherein:
the each movable platform includes one or more one guiding members disposed along the length of the each movable platform, the one or more guiding members having a first end, a second end, and a length therebetween; and
the one or more stabilizing support members are configured to move along the one or more guiding members.

3. The surgical support apparatus according to claim 2, wherein:
the each movable platform includes one or more securing members;
the one or more stabilizing support members include one or more securing members that are complimentary to the one or more securing members of the each movable platform; and
the one or more securing members are configured removably, actively and/or passively fix the position of the each stabilizing support member with respect to the each movable platform.

4. The surgical support apparatus according to claim 3, wherein the one or more securing members of the each movable platform include one or more of grooves, notches, slots, protrusions, posts, cut-outs and/or any combination thereof.

5. The surgical support apparatus according to claim 4, wherein the one or more securing members of the each stabilizing support member include one or more of grooves, notches, slots, protrusions, posts, channels, and/or combination thereof.

6. The surgical support apparatus according claim 1, wherein the one or more stabilizing support members are configured to be fixedly disposed with respect to the movable support in one of more orientations.

7. The surgical support apparatus according to claim 6, wherein the one or more stabilizing support members include a first surface, a second surface perpendicular to the first surface, a third surface extending between the first and second surface.

8. The surgical support apparatus according to claim 7, wherein the third surface is curved.

9. The surgical support apparatus according to claim 1, wherein the one or more platforms include a platform fixed to the first end of the frame body and the movable platform is configured to move with respect to the platform and the second end of the frame body.

10. The surgical support apparatus according to claim 9, wherein:
the one or more movable platforms include a first movable platform and a second movable platform; and
the first movable platform and the second movable platform are configured to move with respect to each other along the length of the frame body and the frame body.

11. A surgical support apparatus, comprising:
a frame body having a first end, a second end, and a length therebetween;
one or more platforms disposed on the frame body, the one or more platforms including a first movable platform and a second movable platform, each of the first and second movable platforms having a first end, a second end, and a length therebetween, each of the first and second moveable platforms being configured to move along the length of the frame body and with respect to each other; and
one or more stabilizing support members being configured to move along the length of each of the first and second movable platforms, each stabilizing support member including a first flat surface and a second flat surface perpendicular to the first flat surface, the first flat surface being longer than the second flat surface,
wherein the one or more stabilizing support members include one or more securing members disposed on the first flat surface and/or the second flat surface, the one or more securing members being configured to removably, actively and/or passively fix a position of the each stabilizing support member along the length of each of the first and second movable platforms.

12. The surgical support apparatus according to claim 11, wherein:
each of the first and second movable platforms includes one or more one guiding members disposed along the length, the one or more guiding members having a first end, a second end, and a length therebetween; and
the one or more stabilizing support members are configured to move along the one or more guiding members.

13. The surgical support apparatus according to claim 12, wherein:
each of the first and second movable platforms include one or more securing members;
the one or more stabilizing support members include one or more securing members that are complimentary to the one or more securing members of the each movable platform; and
the one or more securing members are configured removably, actively and/or passively fix the position of the each stabilizing support member with respect to each of the first and second movable platforms.

14. The surgical support apparatus according to claim 13, wherein the one or more securing members of the each movable platform include one or more of grooves, notches, slots, protrusions, posts, cut-outs and/or any combination thereof.

15. The surgical support apparatus according to claim 14, wherein the one or more securing members of the each stabilizing support member include one or more of grooves, notches, slots, protrusions, posts, channels, and/or combination thereof.

16. The surgical support apparatus according claim 11, wherein each of the first flat surface and the second flat surface are configured to be disposed on and be moved with respect to each of the first and second platforms.

17. The surgical support apparatus according to claim 16, wherein each stabilizing support member includes a third surface extending between the first and second surface, the third surface being curved.

18. The surgical support apparatus according to claim 11, wherein the one or more platforms includes a fixed platform that is fixed to the first end of the frame body and the first and second movable platforms are configured to move with respect to the platform and the second end of the frame body, the first movable platform being disposed between the second movable platform and the fixed platform with respect to the length of the frame body.

19. The surgical support apparatus according to claim 18, wherein:
each of the fixed, first movable, and second movable platforms include a platform base that is disposed on the frame body and on which the one or more stabilizing support members are disposed; and
the platform base of the first movable platform is higher than the platform base of the second movable platform and the platform base of the fixed platform.

20. The surgical apparatus of claim 19, wherein:
the frame body is configured to be disposed on a surgical bed;
the fixed platform is configured to support the thoracic region of a patient;
the first movable platform is configured to support the pelvic region of the patient; and
the second movable platform is configured to support the thigh region of the patient.
